(19) United States
(12) Patent Application Publication
(10) Pub. No.: US 2022/0267068 A1
(43) Pub. Date: Aug. 25, 2022

(54) MULTILAYER ARTICLE COMPRISING ENZYMES

(71) Applicant: CARBIOLICE, Riom (FR)

(72) Inventor: Clementine ARNAULT, Clermont Ferrand (FR)

(21) Appl. No.: 17/598,746

(22) PCT Filed: Mar. 27, 2020
(86) PCT No.: PCT/EP2020/058796

§ 371 Date: May 13, 2022

(30) Foreign Application Priority Data
Mar. 28, 2019 (FR) 1903237

(51) Int. Cl. B65D 65/46; B29C 48/08; B29C 48/21; B32B 27/18

(52) U.S. Cl. CPC B65D 65/466; B29C 48/08; B29C 48/21; B32B 27/18; B29K 2105/0017

(57) ABSTRACT

The invention relates to a biodegradable multilayer plastic article comprising at least 3 layers and a core that contains enzymes capable of degrading the polymers of the layers that surround the core.

### FIELD OF THE INVENTION

The present invention relates to a biodegradable multilayer plastic article comprising at least 3 layers and a core which contains enzymes capable of degrading the polymers of the layers that surround it.

### PRIOR ART

Biobased and biodegradable articles are known, in particular single or multilayer articles, used in particular for the manufacture of plastic bags. These bags are in particular used for the packaging of food products, in particular fruit and vegetables.

Particular mention may be made of the articles described in patents and patent applications WO 2007/118828, WO 2002/059202A1, WO 2002/059199, WO 2002/059198, WO 2004/052646, WO 2018/233888, U.S. Pat. Nos. 6,841,597, 8,751,816, 5,436,078, 9,096,758, US 2009/324917 and CN 106881929.

To produce an article comprising enzymes capable of degrading the polymers of which it is composed, it is necessary both to preserve the enzymes during article preparation, for example by mixing with polymers that melt at temperatures that do not degrade said enzymes, while respecting the constraints of mechanical properties and barriers, particularly to gases.

### DISCLOSURE OF THE INVENTION

The invention relates to a biobased and biodegradable multilayer plastic article comprising at least 3 layers including a core that contains enzymes capable of degrading the polymers of the layers that surround it.

The article in accordance with the invention is an ABA, ABCA or ACBCA type multilayer article, comprising a central layer B which comprises at least 0.001% of enzymes capable of degrading the polymers of the adjacent layers A and optionally C, the percentages being expressed by mass based on the total mass of the composition of layer B.

The multilayer article in accordance with the invention can be a flexible article such as a film, a bag, a mailing film, a mulching film.

The flexible article of this invention will preferentially have a thickness of less than 250 μm.

The multilayer article in accordance with the invention may also relate to a rigid article such as a cup, a plate, a beverage capsule, a tray, a blister pack.

The rigid article of this invention will have a thickness comprised between 150 μm and 5 mm, preferentially comprised between 150 μm and 3 mm.

### DETAILED DESCRIPTION OF THE INVENTION

The article in accordance with the invention is an ABA, ABCA or ACBCA type multilayer thermoplastic article. The central layer B is the one which comprises the enzymes capable of degrading the polymers of layers A, B and, if need be, C.

An ABA, ABCA or ACBCA type multilayer thermoplastic article is understood to mean, in accordance with the invention, an article whose layers are interlinked and not simply associated by simple juxtaposition. In particular and preferably, the layers are interlinked by coextrusion.

Unless otherwise stated, percentages and relative ratios are expressed by mass based on the total mass of the composition they define.

Layer A is advantageously a layer of biodegradable polyesters used alone or in a mixture in any proportions. These polyesters are well known to the person skilled in the art, in particular selected from PBAT (polybutylene adipate terephthalate), PHA (polyhydroxyalkanoate), PHB (poly-β-hydroxybutyrate), PHH (polyhydroxyhexanoate), PBS (polybutylene succinate), PLA (polylactic acid), PCL (polycaprolactone), PBSA (polybutylene succinate adipate) and plasticized starch.

According to a particular embodiment, the polyester of layer A is selected from PBAT, PLA and mixtures thereof in any proportions. According to a preferred embodiment, the PBAT/PLA weight ratio in layer A ranges from 0/100 to 25/75, preferentially from 10/90 to 20/80, even more preferentially from 13/87 to 15/85.

Layer A may also comprise other additives commonly used in the production of plastic articles, such as glidants, plasticizers, nucleating agents, compatibilizers, processing aids, UV stabilizers, impact inhibitors, mineral or vegetable fillers, etc.

The plasticizers used in the flexible article are well known to the person skilled in the art, in particular selected from polyols and amides, lactic acid oligomers (OLAs) and citrate esters.

OLAs are plasticizers known to the skilled person, in particular as biobased materials. These are lactic acid oligomers with a molecular weight below 1500 g/mol. They are preferably esters of lactic acid oligomers, their carboxylic acid end being blocked by esterification with an alcohol, in particular a linear or branched C1-010 alcohol, advantageously a C6-C10 alcohol, or a mixture of the latter. Particular mention may be made of the OLAs described in patent application EP 2 256 149 with their method of preparation, and of the OLAs sold by the company Condensia Quimica under the brand name Glyplast®, in particular the products Glyplast® OLA 2, which has a molecular weight of 500 to 600 g/mol, and Glyplast® OLA 8, which has a molecular weight of 1000 to 1100 g/mol. According to a preferred embodiment of the invention, the OLAs have a molecular weight of at least 900 g/mol, preferably of 1000 to 1400 g/mol, more preferentially of 1000 to 1100 g/mol.

Citrate esters are also plasticizers known to the skilled person, in particular as biobased materials. Particular mention may be made of triethyl citrate (TEC), triethyl acetyl citrate (TEAC), tributyl citrate (TBC), tributyl acetyl citrate (TBAC), preferably TBAC.

The content of plasticizer, in particular OLAs or citrate esters, in the composition in accordance with the invention is advantageously at least 0.5%, preferably from 1 to 5%, more preferentially from 2 to 4%, advantageously about 3%.

Compatibilizers are particularly used in the composition of layer A when PLA is mixed with another polyester. PLA/polyester compatibilizers are well known to the skilled person, in particular molecules with epoxy, acrylate, anhydride, oxazoline and lactam functions which allow grafting reactions.

Among the compatibilizers, more particular mention may be made of polyacrylates, terpolymers of ethylene, acrylic ester and glycidyl methacrylate (for example sold under the brand name Lotader® by the company Arkema), PLA-PBAT-PLA triblock copolymers, PLA grafted with maleic anhydride (PLA-g-AM) or PBAT grafted with maleic anhydride (PBAT-g-AM).

According to a preferred embodiment of the invention, the compatibilizer is selected from polyacrylates, advantageously selected from methacrylate derivatives, preferentially the compatibilizer is poly(ethylene-co-methyl acrylate-co-glycidyl methacrylate). Such compatibilizers are well known and described in particular by Dong et al. (International Journal of Molecular Sciences, 2013, 14, 20189-20203) and Ojijo et al. (Polymer 2015, 80, 1-17). A preferred compatibilizer is poly(ethylene-co-methyl acrylate-co-glycidyl methacrylate) sold under the brand name JONCRYL® ADR-4468-by the company BASF.

The compatibilizer content in the composition of layer A in accordance with the invention is advantageously at least 0.1%, preferably from 0.25 to 2%, more preferentially from 0.3 to 1.5%, advantageously about 0.5% by weight based on the total weight of the composition.

The mineral fillers used preferentially are calcium carbonate or talc.

The vegetable fillers used preferentially are starch and wood fibers and flour.

According to a particular embodiment of the invention, in particular for the preparation of flexible articles, the composition of layer A comprises
at least 25% by weight of PLA (polylactic acid), preferentially at least 28%, more preferentially at least 30% of PLA,
at least 60% by weight of a polyester selected from PBAT (polybutylene adipate terephthalate), PHAs (polyhydroxyalkanoates), PBS (polybutylene succinate), PBSA (polybutylene succinate adipate) and mixtures thereof,
between 0.25 and 1% of a PLA/polyester compatibilizer, in particular selected from the polyacrylates defined above, and
between 2 and 4% of a plasticizer, in particular selected from the lactic acid oligomers (OLAs) and citrate esters defined above.

According to another particular embodiment of the invention, in particular for rigid articles, the composition of layer A comprises
At least 80% by weight of polyester, preferentially at least 85%, more preferentially at least 90%
At most 30% of additives, preferentially at most 15%, more preferentially at most 10%.

In particular, layer A consists essentially of a polyester or a mixture of polyesters as described above, in particular PLA.

The central layer B comprises at least 0.001% of enzyme capable of degrading the polymers of layers A and B, whether they are adjacent or separated by a layer C.

Enzymes capable of degrading polymers are well known to the skilled person. Particular mention will be made of enzymes capable of degrading polyesters so as to improve the biodegradability of the article in accordance with the invention. In a particular embodiment of the invention the enzymes are capable of degrading PLA. Such enzymes and their method of incorporation in thermoplastic articles are known to the skilled person, in particular described in patent applications WO 2013/093355, WO 2016/198652, WO 2016/198650, WO 2016/146540 and WO 2016/062695. Preferentially these enzymes are selected from proteases and serine proteases. In a particular embodiment, the serine proteases are selected from Proteinase K from Tritirachium album, or PLA-degrading enzymes from Amycolatopsis sp., Actinomadura keratinilytica, Laceyella sacchari LP175, Thermus sp. or Bacillus licheniformis or reformulated commercial enzymes known to degrade PLA such as Savinase®, Esperase®, Everlase® or any enzyme of the subtilisin CAS 9014-01-1 family or any functional variant.

Skilled persons will adapt the enzyme content in the central layer B as a function of their objectives for degrading the polyesters of the layers B and A which surround it. Advantageously, the enzyme content in the central layer will be at least 0.002%, more advantageously at least 0.05%. These contents may be as high as 10%, indeed higher. Although it is possible to formulate compositions for layer B comprising more than 10% of enzymes, it is nevertheless rare for such contents to be exceeded for the most frequent uses of the plastic articles in accordance with the invention. Advantageously, the enzyme content in the composition of layer B is from 0.01 to 7%, preferably from 0.02 to 5%.

Layer B comprises, in addition to the enzymes, constituent polymers of this layer. According to a preferred embodiment of the invention, these constituent polymers are selected from polymers capable of being degraded by the enzymes which they contain, in particular the polyesters defined above for layer A. These constituent polymers may also be selected from barrier materials such as PVOH (polyvinyl alcohol), PVCD (polyvinyl chloride), PGA (polyglycolic acid), cellulose and derivatives thereof, milk proteins, or polysaccharides and mixtures thereof, employed alone or in mixtures with the abovementioned polyesters.

As for layer A, the polyesters are in particular selected from the biodegradable polyesters and copolymers thereof, in particular PBAT (polybutylene adipate terephthalate), PHA (polyhydroxyalkanoate), PHB (poly-β-hydroxybutyrate) PHH (polyhydroxyhexanoate), PBS (polybutylene succinate), PLA (polylactic acid), PCL (polycaprolactone), PBSA (polybutylene succinate adipate) and plasticized starch and mixtures thereof in any proportions.

According to a particular embodiment of the invention, the constituent polymers of layer B in accordance with the invention have a lower melting temperature than that of the constituent polymers of layer A.

The enzymes may be added directly to the polymers of layer B during its preparation, or as a concentrated premix in a low-melting-point carrier polymer. Such compositions are described in particular in application WO 2019/043134, They advantageously comprise a carrier polymer having a melting temperature below 140° C. and/or a glass transition temperature below 70° C. and a polysaccharide.

Polymers having a melting temperature below 140° C. and/or a glass transition temperature below 70° C. are well known to the skilled person. These are in particular polycaprolactone (PCL), polybutylene succinate adipate (PBSA), polybutylene adipate terephthalate (PBAT), polyhydroxyalkanoate (PHA), polylactic acid (PLA), or copolymers thereof. They may also be a natural polymer such as starch or a polymer that can be described as universal, i.e., compatible with a wide range of polymers, such as an EVA-type copolymer. Advantageously, the carrier polymer has a melting temperature below 120° C. and/or a glass transition temperature below 30° C.

The polysaccharides are in particular selected from starch derivatives such as amylose, amylopectin, maltodextrins, glucose syrup, dextrins and cyclodextrins, natural gums such as gum arabic, gum tragacanth, guar gum, locust bean gum, karaya gum, mesquite gum, galactomannans, pectin or soluble soybean polysaccharides, marine extracts such as carrageenans and alginates, and microbial or animal polysaccharides such as gellans, dextrans, xanthans or chitosan, and mixtures thereof. A preferred polysaccharide is gum arabic.

A preferred enzyme composition comprises, in particular, from 50 to 95% of a low-melting-point polymer, in particular polycaprolactone (PCL), preferentially from 70 to 90%, from 0.001 to 10% of enzymes, preferentially from 1 to 6%, and from 1 to 30% of gum arabic, preferentially from 10 to 25%.

According to a particular embodiment of the invention, layer B consists essentially of the above enzyme composition (the carrier polymer is also the constituent polymer). The composition may be supplemented by the usual additives described below.

According to another embodiment of the invention, the enzyme composition is added to the constituent polymer(s) previously described according to the usual methods, in sufficient amounts to provide the desired amount of enzymes sought for layer B. The content of enzyme composition in layer B will depend in particular on the content of enzymes in the enzyme composition, advantageously from 1 to 10% based on the total weight of the composition of layer B.

According to a particular embodiment, layer B comprises, in addition to the polymers constituting it and the enzymes, a carrier polymer and a polysaccharide as defined above.

According to a particular embodiment of the invention, layer B comprises
from 80 to 99% of constituent polymer, preferably from 90 to 99%
from 0 to 40% of polysaccharide, preferably from 0.1 to 4%
from 0 to 40% of a carrier polymer, preferably from 3 to 6% and
from 0.005 to 10% of enzymes, preferably from 0.01 to 5%, more preferentially from 0.01 to 3%.

According to a more particular embodiment of the invention, the enzyme content in the above layer B composition ranges from 0.02 to 1%.

The composition of layer B may also comprise usual additives, as for the composition of layer A. In particular, when the constituent polymer comprises a mixture of PLA and another polyester, the composition will advantageously comprise a compatibilizer and a plasticizer, as defined above.

According to a particular embodiment of a flexible article of the invention, the composition of layer B comprises
at least 20% of PLA, advantageously at least 25% of PLA
at least 40% of PBAT
at least 0.08% of PLA/PBAT compatibilizer as defined above, advantageously at least 0.5%
at least 0.4% of plasticizer, in particular selected from the OLAs and citrate esters described above,
at least 0.002% of enzyme, advantageously at least 0.05%,
at least 1.4% of a carrier polymer as described above, advantageously at least 1.5%, and
if need be, a polysaccharide.

According to a particular embodiment of a rigid article of the invention, the composition of layer B comprises
at least 90% of PLA, advantageously at least 95% of PLA
at least 0.002% of enzyme, advantageously at least 0.05%,
at least 1.4% of a carrier polymer as described above, advantageously at least 1.5%, and
if need be, a polysaccharide.

According to another particular embodiment of a rigid article of the invention, the composition of layer B comprises
at least 40% of PLA, advantageously at least 50% of PLA
at least 15% of PBAT, advantageously at least 20% of PBAT
at least 5% of a mineral filler, advantageously at least 10% of a mineral filler
at least 0.002% of enzyme, advantageously at least 0.05%,
at least 1.4% of a carrier polymer as described above, advantageously at least 1.5%, and
if need be, a polysaccharide.

According to certain embodiments of the invention, the multilayer article may comprise one or two layers C between the outer polyester layer A and the layer B which comprises the enzymes (ABCA or ACBCA). These layers C are there to provide particular properties to the articles in accordance with the invention, more particularly to provide barrier properties to gases and in particular to oxygen.

Such barrier materials are well known to the skilled person, and in particular PVOH (polyvinyl alcohol), PVCD (polyvinyl chloride), PGA (polyglycolic acid), cellulose and derivatives thereof, milk proteins, or polysaccharides and mixtures thereof in any proportions, as mentioned above for those which can also enter into the composition of layer B.

The PVOH used as a barrier material in the preparation of the article is well known. It is a polyvinyl alcohol whose degree of polymerization is comprised between 300 and 2500. Its melting point is below 210° C. and its viscosity is comprised between 3 and 60 mPa·s.

The PVCD used as a barrier material in the preparation of the article is well known. It is polyvinylidene chloride derived from the copolymerization of vinylidene chloride (85%) and vinyl chloride (15%).

The PGA used as a barrier material in the preparation of the article is well known. It is polyglycolic acid whose melting temperature is 220° C. and glass transition temperature is 40° C.

Among the celluloses, more particular mention may be made of microfibrillated celluloses (MFCs) and cellulose acetate.

The MFCs used as barrier material have a diameter comprised between 4 and 10006 nm and a density comprised between 0.51 and 1.57 g/cm³.

Among the milk proteins used as barrier materials, more particular mention may be made of casein, β-lactoglobulin and α-lactalbumin as well as immunoglobulins, serum albumin, lactoferrin and enzymes including plasmin.

The polysaccharides used as barrier materials are also well known to the skilled person. More particular mention may be made of galactomannans, pectin or soluble soybean polysaccharides, marine extracts such as carrageenans and alginates, and microbial or animal polysaccharides such as gellans, dextrans, xanthans, xylans or chitosan, and mixtures thereof.

As for layers A and B, layer C may also comprise additives commonly used in the production of plastic articles, such as glidants, plasticizers, nucleating agents, compatibilizers, processing aids, UV stabilizers, impact inhibitors, mineral or vegetable fillers, etc.

According to a preferred embodiment of the invention, the composition of layer C is the following
90 to 100% of barrier materials as defined above, and
0 to 10% of additives.

Preferably layer C comprises more than 95% of barrier material, even more preferentially 99% or more.

PVOH is a preferred barrier material for the layers C of the articles in accordance with the invention.

The flexible multilayer article in accordance with the invention advantageously has a thickness of less than 250 μm, preferentially less than 100 μm, 50 μm, 40 μm or 30 μm. According to a preferred embodiment of the invention, the thickness of the multilayer article ranges from 10 to 20 μm.

The rigid multilayer article in accordance with the invention advantageously has a thickness greater than 150 μm, preferentially less than 5000 μm. According to a preferred embodiment of the invention, the thickness of the multilayer article ranges from 150 to 3000 μm.

The relative thickness of each layer of the ABA, ABCA or ACBCA article in accordance with the invention may vary according to the final properties sought for the article, particularly in terms of strength but also of biodegradability.

Advantageously, each layer A independently represents from 5 to 30% of the total thickness of the article and the central layer B represents from 40 to 90% of the total thickness of the article. Preferably, the central layer B represents from 50 to 90% of the total thickness of the article.

In a preferred embodiment of the flexible article of the invention, the two layers A have an identical thickness, each representing from 15 to 30% of the total thickness of the article, preferentially from 16 to 25%.

In a preferred embodiment of the rigid article of the invention, the two layers A have an identical thickness, each representing from 2 to 20% of the total thickness of the article, preferentially from 3 to 15%.

The layers C, when present, generally have a thickness of less than 15 μm. They individually represent less than 10% of the total thickness of the article.

According to a particular embodiment of the invention, the layers C, when present, of the multilayer flexible articles have a thickness of less than 3 μm. They individually represent less than 30% of the article.

According to a particular embodiment of the invention, the layers C, when present, of the multilayer rigid articles have a thickness of less than 20 μm. They individually represent less than 30% of the article.

The compositions of layers A, B and C are prepared by the usual techniques for preparing polymer compositions.

The skilled person will know how to prepare the multilayer article in accordance with the invention, by all the usual techniques which allow their linking, such as coextrusion, calendering, injection, lamination, in particular by extrusion. Preferably, the article is prepared by coextrusion of the layers, the skilled person being able to determine the conditions for implementing the process, and in particular the mixture of the components entering into the composition of each of the layers. Advantageously, the coextrusion is carried out at a temperature below 200° C.

The article in accordance with the invention can be used for all common uses of thermoplastic articles, and in particular for the preparation of packaging or bags, or for mulching or mailing. It can also be used for the preparation of disposable tableware (plates, glasses), packaging (trays, blister packs) or beverage capsules.

Advantageously, the rate of biobased material for producing the article in accordance with the invention is greater than 30%, preferentially greater than 40%.

### Examples

Materials and Methods

I. Preparation of PBAT and PLA Mixture Pellets

The pellets were produced on a Clextral Evolum 25 HT co-rotating twin-screw machine. To introduce the polymers (PLA and PBAT) and the compatibilizer, two gravimetric dosing units were used and, to dose the liquid TBAC, a PCM pump was used.

The PLA and Joncryl® mixture was introduced via a dosing unit at the beginning of the screw in the presence of the TBAC plasticizer. The mixture is melted and fed into the PBAT introduction zone.

The pellets were prepared with a screw speed of 450 rpm and a flow rate of 40 kg/h.

The parameters used for pellet extrusion are shown in Table [1].

TABLE 1
Temperature profile (° C.) used for pellet extrusion

| Zone | Z1 | Z2 | Z3 | Z4 | Z5 | Z6 | Z7 | Z8 | Z9 | Z10 | Z11 |
|---|---|---|---|---|---|---|---|---|---|---|---|
| Temperature | 50 | 195 | 195 | 195 | 195 | 195 | 195 | 195 | 195 | 195 | 195 |

The mixture of the components is melted in the screw in Z11 and immediately pelleted with a wet cutting system to obtain half-moon shaped pellets with a diameter of less than 3 mm.

A composition of the prior art is prepared comprising 35% of PLA and 61% of PBAT, 3% of TBAC and 1% of Joncryl® ADR 4468 C (% by weight based on the total weight of the composition).

II. Preparation of a Carrier Polymer and Enzyme Mix

The carrier polymer and enzyme mix is prepared from polycaprolactone (PCL) pellets and the enzyme in liquid form as described in application WO 2019/043134.

The carrier polymer and enzyme mix was manufactured using a CLEXTRAL EV25HT twin-screw extruder with 11 independently temperature-controlled zones. The PCL is introduced in zone 1 at 16 kg/h and the enzyme solution in zone 5 at 4 kg/h using a peristaltic pump. The zones are heated according to Table [2]. 20% of the enzyme solution is added to the PCL (% by weight based on the total weight).

TABLE 2
Temperature profile (° C.) used for the
carrier polymer and enzyme mix

| Zone | Z1 | Z2 | Z3 | Z4 | Z5 | Z6 | Z7 | Z8 | Z9 | Z10 | Z11 |
|---|---|---|---|---|---|---|---|---|---|---|---|
| Temperature | 40 | 65 | 75 | 75 | 60 | 60 | 60 | 60 | 60 | 60 | 60 |

III. Commercial Products

In these examples, PLA sold under the product name Ingeo™ Biopolymer 4043D by the company NatureWorks and under the product name Luminy® LX175 sold by the company Total Corbion, PCL sold under the product name Cape™ 6500 by the company Perstorp, Joncryl® ADR 4468 sold by the company BASF, TBAC Citrofol® BII sold by the company Jungbunzlauer, PBAT sold under the product name A400 by the company Wango, biodegradable compounds sold under the product name Mater-Bi by Novamont and under the product name Biolice.Bags 6040T by the company Carbiolice.

### IV. Production of Films

For the preparation of multilayer films, an Eurexma three-layer coextrusion blowing line, width 275-300 mm and screw of L/D=30 is used. The blowing rate was about 3.5-3.9. The settings and temperatures are detailed in Tables [3] and [4].

TABLE 3
Extruder and die temperature parameters (° C.)

| | Extruder | | | | Die | | |
|---|---|---|---|---|---|---|---|
| | Z1 | Z2 | Z3 | Z4 | Z1 | Z2 | LIN |
| Inner A | 165-130 | 165-135 | 165-135 | 170-140 | 160-145 | 155-145 | 150-145 |
| Central B | 155-150 | 155-150 | 160-150 | 160-150 | | | |
| Outer A | 165-130 | 165-135 | 165-135 | 170-140 | | | |

TABLE 4
Extruder process parameters

| | Screw A | Screw B | Screw A |
|---|---|---|---|
| | (internal) | (center) | (external) |
| Layer distribution % | 20 | 60 | 20 |
| Screw speed (rpm) | 25-11 | 80-35 | 25-11 |

### V. Production of Rigid Sheets

For the preparation of the rigid sheets, a three-layer calendering coextrusion line is used. A FAIREX extruder with a diameter of 45 is used for layer B; a SCAMEX extruder with a diameter of 30 and Davis standard with a diameter of 30 for layers A. The flat die used is 220 mm and is equipped with an adjustable lip with a nominal opening of 1.5 mm and an ABA co-extrusion box. The settings and temperatures are detailed in Table 5.

TABLE 5
Temperature parameters (° C.) of the extruder, the die
and the calendering line

| | | | | | Die | | | | Calender |
|---|---|---|---|---|---|---|---|---|---|
| | Extruder | | | | Distribution | | | | Cylinders |
| | Z1 | Z2 | Z3 | Z4 | box | Z1 | Z2 | Z3 | 1, 2 and 3 |
| Inner A | 140-155 | 150-165 | 150-165 | 150-165 | 155-165 | 155-165 | 155-165 | 155-165 | 10-30 |
| Central B | 140 | 150-165 | 150-165 | 150-165 | | | | | |
| Outer A | 140-155 | 150-165 | 150-165 | 150-165 | | | | | |

TABLE 6
Process parameters of the extruder, the die and the calendering line

| | | |
|---|---|---|
| Screw A | Screw B | Screw A |
| (internal) | (center) | (external) |

Extruder

| | | | |
|---|---|---|---|
| Layer distribution % | 5 | 90 | 5 |
| Screw speed (rpm) | 35 | 35-40 | 35 |

Die

| | |
|---|---|
| Lip opening (mm) | 0.5 |

Calender

| | |
|---|---|
| Pulling speed (m/min) | 2-4 |
| Air gap between cylinders | Open |
| 1 and 2 (mm) | |
| Air gap between cylinders | 0.45 |
| 2 and 3 (mm) | |

### VI. Method of Analysis

The mechanical properties of the films are measured according to standard EN ISO 527-3 (Plastics—Determination of tensile properties—Part 3: Test conditions for films and sheets).

The biodegradability of the films was assessed with a depolymerization test performed according to the following protocol: 100 mg of each sample was introduced into a plastic vial containing 50 mL of buffer solution at pH 9.5. Depolymerization was initiated by incubating each sample at 45° C., in an incubator shaken at 150 rpm. A 1 mL aliquot of the buffer solution is regularly withdrawn and filtered through a 0.22 μm filter syringe in order to be analyzed by high-performance liquid chromatography (HPLC) with an Aminex HPX-87H column to measure the release of lactic acid (LA) and its dimer. The chromatography system used is an Ultimate 3000 UHPLC system (Thermo Fisher Scientific, Inc. Waltham, Mass., USA) comprising a pump, an autosampler, a column thermostated at 50° C. and a UV detector at 220 nm. The eluent is 5 mM H₂SO₄. The injection is 20 μL of sample. Lactic acid is measured from standard curves prepared from commercial lactic acid.

The hydrolysis of the plastic films is calculated from the lactic acid and lactic acid dimer released. The percentage of depolymerization is calculated in relation to the percentage of PLA in the sample.

Results

### VII. Film Composition and Results

The films were prepared with the pellets prepared in I and the carrier polymer and enzyme mix prepared in II, PBAT and Biolice.Bags 6040T.

The central layer B is prepared with the pellets prepared in I and carrier polymer or with the pellets prepared in I and the carrier polymer and enzyme mix prepared in II.

The outer layers A consist of PBAT (100%) or Biolice.bags 6040T (100%).

For the films, the relative thickness of each A/B/A layer is 20%/60%/20%.

The compositions of these different films are listed in Table [7] below.

TABLE 7
Summary of multilayer films produced

| | | | | Overall |
|---|---|---|---|---|
| | Layer A | Layer B | Layer A | enzyme |
| | (inner) | (center) | (outer) | content (%) |
| Layer | 20 | 60 | 20 | — |
| distribution % | | | | |
| Film 1 | Biolice.bags | Pellets I + | Biolice.bags | 0% |
| | 6040T | carrier | 6040T | |
| | | polymer | | |
| Film 2 | Biolice.bags | Pellets I + | Biolice.bags | 0.134% |
| | 6040T | mix II | 6040T | |
| Film 3 | PBAT | Pellets I + | PBAT | 0% |
| | | carrier | | |
| | | polymer | | |
| Film 4 | PBAT | Pellets I + | PBAT | 0.114% |
| | | mix II | | |

The films 1 and 3 serve as references of the prior art for the films 2 and 4 of the invention, respectively.

The presence of the mix has no impact on the extrusion blowing process. The process parameters remain identical between the films of the prior art and of the invention.

The mechanical properties thus measured show that the films disclosed in the invention have mechanical properties maintained and consistent with the field. The results are presented in Table [8].

TABLE 8
Characterization of the mechanical properties of the films

| | | Film | | | |
|---|---|---|---|---|---|
| | | 1 | 2 | 3 | 4 |
| | Measuring | thickness (μm) | | | |
| Property | direction | 13.4 | 13.4 | 9.2 | 9.2 |
| Stress at break | LD | 100% ± | 95.5 ± | 100% ± | 136.2% ± |
| (%) | | 6.6 | 14.4 | 15.8 | 16.7 |
| | TD | 100% ± | 104.8 ± | 100% ± | 98.8% ± |
| | | 17.8 | 15.6 | 6.1 | 17.7 |
| Elongation at | LD | 100% ± | 89.4% ± | 100% ± | 207.3% ± |
| break (%) | | 12.3 | 23.5 | 10.7 | 36 |
| | TD | 100% ± | 70.6% ± | 100% ± | 143% ± |
| | | 6.1 | 14.1 | 21.6 | 65.9 |
| Young's | LD | 100% ± | 114.1 ± | 100% ± | 177.5% ± |
| modulus (%) | | 15.7 | 11.2 | 29.4 | 20.1 |
| | TD | 100% ± | 103.3 ± | 100% ± | 137.4% ± |
| | | 35.8 | 12.4 | 23.6 | 10.1 |
| Tear | LD | 100% ± | 95% ± | 100% ± | 74.4% ± |
| resistance (%) | | 9.4 | 4.2 | 30.8 | 26.2 |
| | TD | 100% ± | 83.8% ± | 100% ± | 103.4% ± |
| | | 6.8 | 9.8 | 7.2 | 19.9 |

(with LD = Longitudinal direction of the film and TD = Transverse direction of the film)

The biodegradability of the films was assessed according to the method described in V.

Films 1 and 3 which do not contain the carrier polymer and enzyme mix have a zero depolymerization rate.

Films 2 and 4 in accordance with the invention have depolymerization rates of 6.7% and 8.4% after 9 days, respectively.

### VIII. Sheet Composition and Results

The sheets were prepared with PLA, Biolice.Bags 6040T, Mater-Bi and the mix prepared in II.

The central layer B is prepared with PLA or Mater-Bi and the carrier polymer or with PLA or Mater-Bi and the mix prepared in II.

The outer layers A consist of PLA (100%) or Biolice.bags 6040T (100%) or Mater-Bi (100%).

For the films, the relative thickness of each A/B/A layer is 5%/90%/5%.

The compositions of these different sheets are listed in Table [9] below.

TABLE 9
Summary of the multilayer sheets produced

| | | | | Overall |
|---|---|---|---|---|
| | Layer A | Layer B | Layer A | enzyme |
| | (inner) | (center) | (outer) | content (%) |
| Layer | 5 | 90 | 5 | — |
| distribution % | | | | |
| Sheet 1 | PLA | PLA + | PLA | 0% |
| | | carrier | | |
| | | polymer | | |
| Sheet 2 | PLA | PLA + | PLA | 0.397% |
| | | mix II | | |
| Sheet 3 | Biolice.bags | PLA + | Biolice.bags | 0% |
| | 6040T | carrier | 6040T | |
| | | polymer | | |
| Sheet 4 | Biolice.bags | PLA + | Biolice.bags | 0.397% |
| | 6040T | mix II | 6040T | |
| Sheet 5 | Mater-Bi | Mater-Bi + | Mater-Bi | 0% |
| | | carrier | | |
| | | polymer | | |
| Sheet 6 | Mater-Bi | Mater-Bi + | Mater-Bi | 0.397% |
| | | mix II | | |
| Sheet 7 | Biolice.bags | Mater-Bi + | Biolice.bags | 0% |
| | 6040T | carrier | 6040T | |
| | | polymer | | |
| Sheet 8 | Biolice.bags | Mater-Bi + | Biolice.bags | 0.397% |
| | 6040T | mix II | 6040T | |

The presence of the mix has no impact on the process. The process parameters remain identical between the sheets of the prior art or of the invention.

1. A biodegradable multilayer thermoplastic article of the type ABA, ABCA or ACBCA, wherein A, B and C are layers of different compositions, and wherein the central layer B comprises at least 0.001% of enzymes capable of degrading the polymers of the layers A surrounding it, the percentage being given by weight based on the total weight of the composition of layer B.

2. The multilayer article according to claim 1, wherein layer A comprises polyesters selected from PBAT (polybutylene adipate terephthalate), PHA (polyhydroxyalkanoate), PHB (poly-β-hydroxybutyrate), PHH (polyhydroxyhexanoate), PBS (polybutylene succinate), PLA (polylactic acid), PCL (polycaprolactone), PBSA (polybutylene succinate adipate), plasticized starch and mixtures thereof in any proportions.

3. The multilayer article according to claim 1, wherein the polyester of layer A is selected from PBAT, PLA and mixtures thereof in any proportions.

4. The multilayer article according to claim 1, wherein the composition of layer B comprises at least 0.002% of enzyme.

5. The multilayer article according to claim 1, wherein the constituent polymers of layer B are selected from polyesters or barrier materials selected from PVOH (polyvinyl alcohol), PVCD (polyvinyl chloride), PGA (polyglycolic acid), cellulose, milk proteins, or polysaccharides and mixtures thereof in any proportions.

6. The multilayer article according to claim 1, wherein layer B comprises:
an enzyme carrier polymer having a melting temperature below 140° C. and/or a glass transition temperature below 70° C.; and
a polysaccharide.

7. The multilayer article according to claim 1, comprising at least one layer C having a composition comprising gas barrier materials selected from PVOH (polyvinyl alcohol), PVCD (polyvinyl chloride), PGA (polyglycolic acid), cellulose, milk proteins, or polysaccharides and mixtures thereof in any proportions.

8. The multilayer article according to claim 1, wherein the multilayer article is coextruded.

9. The multilayer article according to claim 1, wherein the multilayer article has a thickness of less than 250 μm.

10. The multilayer article according to claim 1, wherein the multilayer article has a thickness greater than 150 μm.

11. A film, the film comprising the multilayer article according to claim 9.

12. (canceled)

13. The multilayer article according to claim 4, wherein the composition of layer B comprises at least 0.05% of enzyme.

14. The multilayer article according to claim 9, wherein the multilayer article has a thickness of less than 100 μm.

15. The multilayer article according to claim 9, wherein the multilayer article has a thickness of 10 to 20 μm.

16. The multilayer article according to claim 10, wherein the multilayer article has a thickness less than 5000 μm.

17. The multilayer article according to claim 1, wherein the multilayer article has a thickness comprised between 250 and 3000 μm.

18. A multilayer plastic article, comprising the multilayer article according to claim 9.

19. A multilayer plastic article, comprising the film according to claim 11.
